(19) United States
(12) Patent Application Publication
(10) Pub. No.: US 2024/0348064 A1
(43) Pub. Date: Oct. 17, 2024

(54) Battery Equalization Method and System

(71) Applicant: Autel Intelligent Technology Corp., Ltd., Shenzhen (CN)

(72) Inventor: Weilin WANG, Shenzhen (CN)

(73) Assignee: Autel Intelligent Technology Corp., Ltd., Shenzhen, GD (CN)

(21) Appl. No.: 18/291,231

(22) PCT Filed: Aug. 3, 2022
(86) PCT No.: PCT/CN2022/109858

§ 371 Date: Jan. 23, 2024

(30) Foreign Application Priority Data
Aug. 23, 2021 (CN) 202110969170.0

(51) Int. Cl. H02J 7/00; B60L 3/00; B60L 58/22; H01M 10/42; H01M 10/44; H01M 10/48

(52) U.S. Cl. CPC H02J 7/0016; H01M 10/4257; H01M 10/441; H01M 10/482; H02J 7/00032; H02J 7/0047; H02J 7/007; H02J 7/007194; B60L 3/0046; B60L 58/22; H01M 2010/4271

(57) ABSTRACT

A battery equalization method, comprising: step A1: according to acquired data information of a battery, determining that the battery is a balanceable battery or a replaceable battery; step A2: charging and discharging a module in the balanceable battery; step A3: monitoring the voltage of each cell in the module and the temperature of the module; and step A4: shunting the equalization current between the cells, so as to ensure that the voltage difference between the cells does not exceed a first preset voltage difference value. Further disclosed is a battery equalization system. By means of the method, a battery can be effectively discriminated, thereby improving the equalization effect, shortening the equalization time, and thus improving the equalization efficiency.

The present application claims priority to the Chinese patent application No. 202110969170.0 entitled “battery equalization method and system” filed on Aug. 23, 2021 to the China National Intellectual Property Administration, the entire contents of which are incorporated herein by reference.

### TECHNICAL FIELD

The present application relates to the technical field of batteries, in particular to a battery equalization method and system.

### BACKGROUND OF THE INVENTION

The development of new energy vehicles is more and more rapid, and the demand for the maintenance of new energy vehicles is gradually increasing. In the field of new energy vehicle maintenance, power battery maintenance occupies a large proportion. Due to the differences in aspects such as the capacity, internal resistance and the influence of ambient temperature among the individual cells in a battery, after each charge and discharge cycle, there will be differences in the capacity or pressure difference among the individual cells in the battery, and a battery management system (BMS) will generally balance the differences.

At present, equalization strategies of new energy vehicles are mainly based on energy dissipation technology to discharge cells with high electric quantities and keep the voltages between the cells at an equilibrium level. With regard to the pressure difference within less than 100 mV, the battery management system is likely to pull down the pressure difference between the cells through long—term equalization. For a battery with a relatively large pressure difference, it is difficult to pull down the pressure difference between the cells due to the limited capacity of BMS to dissipate the electric quantity, and at this time, it is necessary to use an external tool to equalize the battery cells. Most of the electrical cores with the same aging degree can maintain a relatively consistent voltage effect after being equalized by an external equalization tool, so as to improve the service life of a battery. For some electrical cores with large differences in aging degree, or those with partial physical damage, even if an equalization tool is used to equalize the battery, only the fault symptoms of the electrical core are masked. When this part of electrical cores continues to be used, the voltage difference will be quickly enlarged and the mileage of an automobile will be reduced, which is of little significance to the equalization. Generally, replacement must be conducted.

Therefore, in the prior art, when a battery is equalized, the battery cannot be effectively discriminated, and the battery equalization method has poor equalization benefit, low equalization efficiency, and low equalization safety.

### SUMMARY OF THE INVENTION

The present invention proposes a battery equalization method and system, which solves the technical problems of failing to effectively discriminate a battery, poor equalization effect, and low equalization efficiency.

In order to solve the above technical problem, in the first aspect, an embodiment of the present invention proposes a battery equalization method, which includes:
according to acquired data information of a battery, determining that the battery is a balanceable battery or a replaceable battery;
charging and discharging a module in the balanceable battery;
monitoring voltages of each cell in the module and the temperature of the module; and
shunting an equalization current between the cells, so as to ensure that a voltage difference between the cells does not exceed a first preset voltage difference value.

Optionally, the following is performed: querying a database, comparing the acquired data information of a battery with the database, analyzing whether the battery has a fault, and then determining whether the battery is a balanceable battery or a replaceable battery according to a result of analyzing whether the battery has a fault.

Optionally, the following is performed: analyzing whether the battery has a fault by BMS, and then determining whether the battery is a balanceable battery or a replaceable battery according to the result of the analyzing whether the battery has a fault; and
when it is determined that the battery is a replaceable battery, after replacing the replaceable battery, equalization processing is performed on the replaced battery according to a balanceable battery.

Optionally, if it is not possible to analyze whether the battery has a fault via BMS, perform repairment detection on the battery via an equalizer, analyze whether the battery has a fault, and then determine whether the battery is a balanceable battery or a replaceable battery according to the result of analyzing whether the battery has a fault.

When it is determined that the battery is a replaceable battery, after replacing the replaceable battery, equalization processing is performed on the replaced battery according to a balanceable battery.

Optionally, performing repairment detection on the battery via an equalizer, analyzing whether the battery has a fault, and then determining whether the battery is a balanceable battery or a replaceable battery according to the result of analyzing whether the battery has a fault comprise:
analyzing whether the battery has a fault by using an internal resistance method via the equalization instrument, and then determining whether the battery is a balanceable battery or a replaceable battery according to the result of the analyzing whether the battery has a fault; and
if the internal resistance method cannot be determined, determining the battery to be a replaceable battery or a balanceable battery by analyzing the battery using a deep charge-discharging method via the equalization instrument.

Optionally, analyzing the battery using a deep charge-discharging method includes:
firstly charging the battery with a current, after the cells in the battery are fully charged, deeply discharging each cell, and when the SOH of the cells in the battery is lower than a preset SOH value and a difference of the SOH of each cell in the battery is outside a difference threshold, determining that the battery is a replaceable battery; and
when the SOH difference between each cell in the battery is within a difference threshold, and the pressure difference between each cell in the battery exceeds a first preset pressure difference value, determining that the battery is a balanceable battery.

Optionally, the calculation method for the pressure difference of each module in the battery comprises:
marking modules needing to be detected and restored in the battery, calculating an average voltage of each module not marked in the battery, and if a difference between the voltage of each module marked in the battery and the average voltage exceeds a second preset voltage difference value, determining that the battery is a balanceable battery.

Optionally, the calculation method for the pressure difference of each module in the battery comprises:
marking the modules needing to be detected and restored in the battery, selecting an interval unit with the highest probability of the voltage range from the voltages of each module not marked, calculating the average voltage of each module in the interval unit, and if the difference between the voltage of each module marked in the battery and the average voltage exceeds a second preset voltage difference value, determining that the battery is a balanceable battery.

Optionally, selecting the interval unit with the highest probability of a voltage range among the voltages of the unmarked modules comprises:
selecting a maximum voltage value and a minimum voltage value from the voltages of each module which are not marked, subtracting the minimum voltage value from the maximum voltage value to obtain a voltage interval, dividing the voltage interval into a plurality of interval units according to a preset interval range, selecting an interval unit with the most distributed modules, and then calculating the average voltage of each module in the interval unit.

Optionally, the balanceable battery is equalized by the equalizer.

Optionally, the battery data information is acquired by using a diagnostic apparatus, comprising: one or more of battery model, software and hardware version information, total voltage, SOC, and SOH of the battery;
one or more of voltage, temperature, internal resistance, and fault code of a module in the battery; and
one or more of the voltage, temperature, internal resistance, and fault code of a cell in the module.

Optionally, the maximum allowable charge-discharge current is searched in the database according to the current battery model and voltage, and then the charge-discharge is performed using the maximum allowable charge-discharge current.

Optionally, if the minimum voltage of a module in the battery is less than the average voltage and the maximum voltage of the module does not reach a charging cutoff voltage, a charging method is used to equalize the battery, wherein the charging method comprises:
using a safe current voltage to charge the module;
monitoring a cell voltage and a module temperature; and
shunting a cell having a voltage higher than the minimum voltage;
if the minimum voltage of the module is higher than the average voltage and is greater than the cut-off discharging voltage, a discharging method is used to equalize the battery, wherein the discharging method comprises:
discharging the battery;
monitoring the voltage between each cell and the module temperature; and
performing a shunt discharge on a cell having a voltage higher than the average voltage;
if the difference between the voltages of each module and the average voltage exceeds a second preset pressure difference value, or the pressure difference between each cell in the battery exceeds a first preset pressure difference value, a high-power method is used to equalize the battery, wherein the high-power method comprises:
using a safe current voltage to charge each module;
monitoring each cell voltage and module temperature; and
shunting cells above the average voltage; and
if a battery pack can be connected to an acquisition line, and the pressure difference between each cell in the battery exceeds a third preset pressure difference value or after the battery is equalized using the high-power method, the third preset pressure difference value is greater than the first preset pressure difference value, the battery is equalized using a cell method, wherein the cell method comprises:
a positive electrode and negative electrode of the battery having no voltage output and no charging and discharging;
charging or discharging each cell through the acquisition line; and
monitoring the voltage, current and module temperature of each cell through the acquisition line.

Optionally, if the voltage, the current and the module temperature of each cell exceed an allowable working range, the equalizer is controlled to stop working and an alarm signal is sent out.

Optionally, a charging process comprises pre-charging stage, constant current stage, and constant voltage charging stage in sequence.

Optionally, the battery is charged intermittently if the voltage of the battery is higher than an open-circuit voltage during charging and if the voltage of the battery is lower than the open-circuit voltage during discharging.

According to the second aspect, embodiments of the present invention provide a battery equalization system, comprising at least one processor and a memory connected in communication with at least one processor;
wherein the memory stores an instruction program executable by at least one processor, the instruction program being executed by at least one processor to enable at least one processor to execute the battery equalization method.

Compared with the prior art, according to the battery equalization method of the present embodiment, firstly, battery data information about a battery is acquired, then the battery can be determined on the basis of the acquired battery data information, and it is determined that the battery is a balanceable battery or a replaceable battery; and then by charging and discharging the balanceable battery, the voltage of each cell in the module and the temperature of the module are monitored, and the equalization current between each cell is shunted, so that the pressure difference between each cell does not exceed a first preset pressure difference value, thereby completing the equalization of the balanceable battery. Therefore, a battery can be effectively discriminated, thereby improving the equalization effect, shortening the equalization time, and thus improving the equalization efficiency.

### BRIEF DESCRIPTION OF DRAWINGS

One or more embodiments are exemplified by the accompanying drawings corresponding thereto. These exemplified descriptions do not constitute a limitation on the embodiments.

Elements in the drawings having the same reference number designations are illustrated as similar elements, and unless otherwise particularly stated, the drawings do not constitute a proportional limitation.

FIG. 1 is a flowchart of a battery equalization method in an embodiment of the present invention;

FIG. 2 is a flowchart of an analysis between a diagnostic apparatus, an equalizer, a battery, and a cloud platform in an embodiment of the present invention;

FIG. 3 is a principle diagram of a battery equalization method in an embodiment of the present invention;

FIG. 4 is a flowchart for analyzing battery failure by an equalizer in an embodiment of the present invention;

FIG. 5 is a diagram illustrating an analysis of a battery repairment strategy in an embodiment of the present invention;

FIG. 6 is a schematic diagram illustrating a battery equalization method by an equalizer in an embodiment of the present invention;

FIG. 7 is a schematic structural diagram of a battery equalization device in an embodiment of the present invention; and

FIG. 8 is a schematic structural diagram of a battery equalization system in an embodiment of the present invention.

### DETAILED DESCRIPTION OF THE INVENTION

In order to make the present invention readily understood, a more detailed description of the present invention will be rendered with reference to the appended drawings and specific embodiments. It should be noted that when an element is referred to as being “secured” to another element, it can be directly on the other element or one or more intervening elements may be present therebetween. When one element is referred to as being “connected” to another element, it can be directly connected to the other element or one or more intervening elements may be present therebetween. The terms “vertical”, “horizontal”, “left”, “right”, “inner”, “outer”, and the like used herein are for descriptive purposes only.

Unless defined otherwise, all technical and scientific terms used in the specification have the same meaning as commonly understood by one of ordinary skill in the art to which the present invention belongs. The terminology used in the description of the present invention is for the purpose of describing specific embodiments only and is not intended to limit the present invention. As used herein, the term “and/or” includes any and all combinations of one or more of the associated listed items.

Furthermore, the technical features involved in the different embodiments of the present invention described below can be combined with each other as long as they do not conflict with each other.

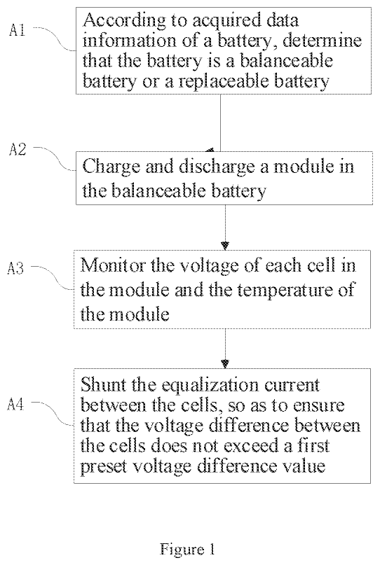

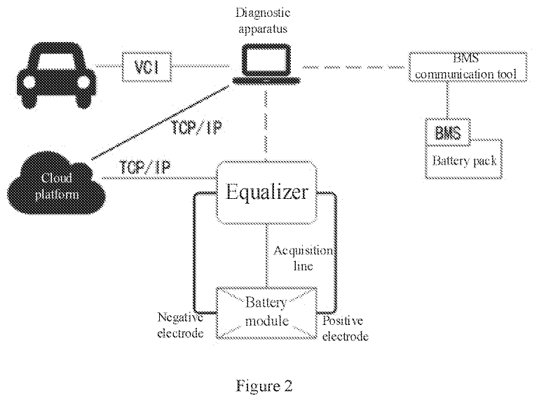

When the consistency of the battery becomes very poor, the use cannot be continued, which greatly affects the balance effect of the battery. How to identify the battery that has aged and cannot be continued is very important. Referring to FIGS. 1 to 2, an embodiment of the present invention provides a battery equalization method, comprising:
A1, according to acquired data information of a battery, determining that the battery is a balanceable battery or a replaceable battery;
A2, charging and discharging a module in the balanceable battery;
A3, monitoring the voltage of each cell in the module and the temperature of the module; and
A4, shunting the equalization current between the cells, so as to ensure that the voltage difference between the cells does not exceed a first preset voltage difference value. The battery data information is acquired by using a diagnostic apparatus, comprising: one or more of battery model, software and hardware version information, total voltage, state of charge (SOC), and state of health (SOH) of a battery; one or more of the voltage, temperature, internal resistance, and fault code of a module in a battery; and one or more of the voltage, temperature, internal resistance, and fault code of a cell in the module.

In the battery equalization method of the present embodiment, firstly, battery data information about a battery is acquired, then the battery can be determined on the basis of the acquired battery data information, and it is determined that the battery is a balanceable battery or a replaceable battery; and then by charging and discharging the balanceable battery, the voltage of each cell in the module and the temperature of the module are monitored, and the equalization current between each cell is shunted, so that the pressure difference between each cell does not exceed a first preset pressure difference value, thereby completing the equalization of the balanceable battery. Therefore, a battery can be effectively discriminated, thereby improving the equalization effect, shortening the equalization time, and thus improving the equalization efficiency.

Referring to FIG. 2, in an embodiment, a diagnostic apparatus is used to acquire battery data information about a battery in a convenient manner to facilitate intelligent detection and battery equalization.

In an embodiment, the diagnostic apparatus acquires battery data information of the battery through a vehicle communication interface (VCI) when the battery is not unloaded from the automobile. At this point, the diagnostic apparatus acquires online BMS battery data information for the battery.

When the battery is unloaded from the automobile, the diagnostic apparatus acquires the battery data information of the battery through the BMS. At this point, the diagnostic apparatus acquires offline BMS battery data information for the battery.

In an embodiment, a database is queried. The acquired battery data information is compared with the database, whether a fault exists in the battery is analyzed, and the battery is determined to be a balanceable battery or a replaceable battery. The database records relevant important data of a battery, including initial capacity, internal resistance, charge-discharge curve characteristics, cyclic aging data, battery failure determination strategy, battery aging threshold, charge-discharge cutoff voltage, nominal voltage, etc. and searches the required data through automobile Make, Mode, and battery model as keywords. The database can be deployed on a diagnostic apparatus or on a cloud platform, and can be acquired from the cloud platform when needed, supporting a complex battery module sorting algorithm, not limited by the computing performance of the equalizer, and can also improve data security. Specifically, TCP/IP is used for communication between the cloud platform and the diagnostic apparatus. The material in the database can be obtained from empirical accumulations or from existing materials. The efficiency of diagnosis is improved by retrieving materials directly from the database.

The BMS function of some automobiles is very powerful. From the data of SOC, SOH, the voltage between cells, etc., whether the cells in the battery are in a normal state can be analyzed, and a corresponding fault code can be given. Analyzing the fault code can prompt the user to replace or equalize the cells.

In an embodiment, a battery is determined to be a balanceable battery or a replaceable battery by analyzing whether the battery has a fault through BMS; and according to the analysis results of BMS, a corresponding maintenance strategy is adopted:
when it is determined that the battery is a replaceable battery, after replacing the battery, performing battery equalization on the replaced battery;
and when it is determined that the battery is a balanceable battery, performing battery equalization on the battery.

Some automobile BMS cannot judge the fault state of an electrical core. Therefore, in an embodiment, if it is impossible to analyze whether the battery is faulty through BMS. A diagnostic apparatus reads BMS related data and transmits the same to an equalizer. The diagnostic apparatus controls the equalizer to repair and detect the battery through the equalizer, analyze whether there is a fault in the battery, and then determine whether the battery is a balanceable or replaceable battery based on the result of the analysis of whether there is a fault in the battery. An equalizer is used to analyze the aging degree and aging consistency of the electrical core, and decide which repair strategy is used to determine whether the battery is a balanceable battery or a replaceable battery, and whether it is necessary to replace the battery, replace the module or equalization module, etc. The communication between the diagnostic apparatus and the equalizer can be performed through USB, BT, Ethernet, WiFI, or serial port, etc. The equalizer communicates with an automobile via an on-board diagnostics (OBD) to acquire BMS data or with a BMS communication tool to acquire BMS data. The equalizer can be a PC, or an embedded integrated machine, or like product forms. Before the equalization, the balanceable batteries and replaceable batteries can be sorted out by a diagnostic apparatus and an equalizer to ensure the implementation of equalization and improve the value and efficiency of battery equalization.

When it is determined that the battery is a replaceable battery, after replacing the replaceable battery, equalization processing is performed on the replaced battery according to a balanceable battery. Namely, charging and discharging a module in the replaced replaceable battery; monitoring the voltage of each cell in the module and the temperature of the module; and shunting the equalization current between the cells, so as to ensure that the voltage difference between the cells does not exceed a first preset voltage difference value.

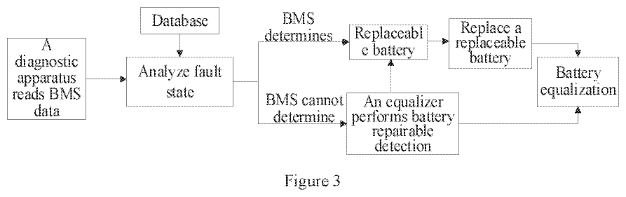

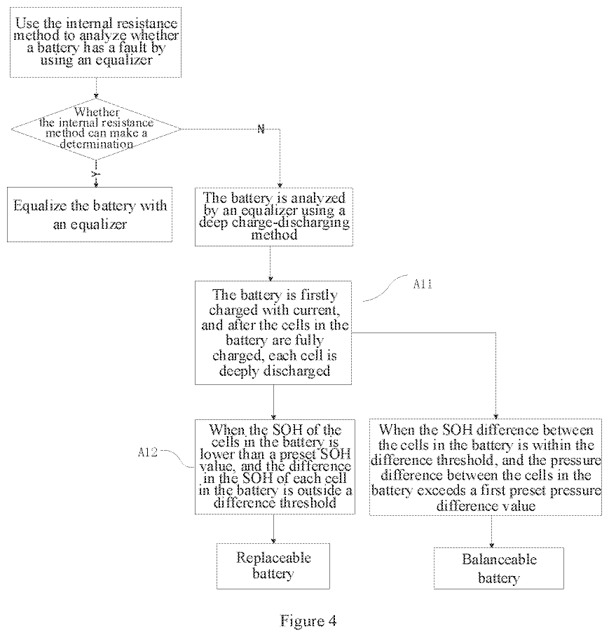

Referring to FIGS. 2-4 together, in an embodiment, a battery repairment detection is performed by an equalizer, whether the battery has a fault is analyzed, and whether the battery is a balanceable battery or a replaceable battery is determined, including:
using an internal resistance method to analyze whether a battery has a fault through an equalizer to determine whether the battery is a balanceable battery or a replaceable battery; and if the internal resistance method cannot make a determination, analyzing the battery by an equalizer using a deep charge-discharging method. Specifically, a deep charge-discharging method is used to determine whether the difference value between the current internal resistance and the initial internal resistance of the battery exceeds a preset internal resistance difference value, and if so, the battery is determined to be a replaceable battery. Internal resistance can be used to preliminarily screen the aging degree of the battery and determine the difference value between the current internal resistance and the initial internal resistance. If the difference value exceeds the preset internal resistance difference value, the battery needs to be replaced.

In an embodiment, analyzing the battery using a deep charge-discharging method includes:
A11, firstly charging the battery with an electric current, and after the cells in the battery are fully charged, deeply discharging each cell; specifically, charging the battery pack with a current of 1 C to ensure that each cell is in a fully charged state, and then deeply discharging each cell to calculate the battery discharge capacity SOC; and
A12, when the SOH of individual cells in the battery is lower than a preset SOH value, and the difference in the SOH of each individual cell in the battery is outside a difference threshold, determining that the battery is a replaceable battery; and
when the SOH difference between each cell in the battery is within a difference threshold, and the pressure difference between each cell in the battery exceeds a first preset pressure difference value, determining that the battery is a balanceable battery. The SOH is calculated according to the discharge capacity SOC and the nominal capacity SOCo of the battery, and then the battery is determined to be a balanceable battery or a replaceable battery according to the SOH. If the SOC difference between the cells is large, in step A11, the cells can be charged separately to ensure that each cell reaches a fully charged state. In step A12, SOH is calculated based on the relationship between the discharge capacity SOC and the nominal capacity SOCo of the battery.

The embodiment provides a BMS acquisition method, an internal resistance method, and a deep charge-discharging method for analyzing a battery so as to judge a battery state in as fast a time as possible to improve analysis efficiency.

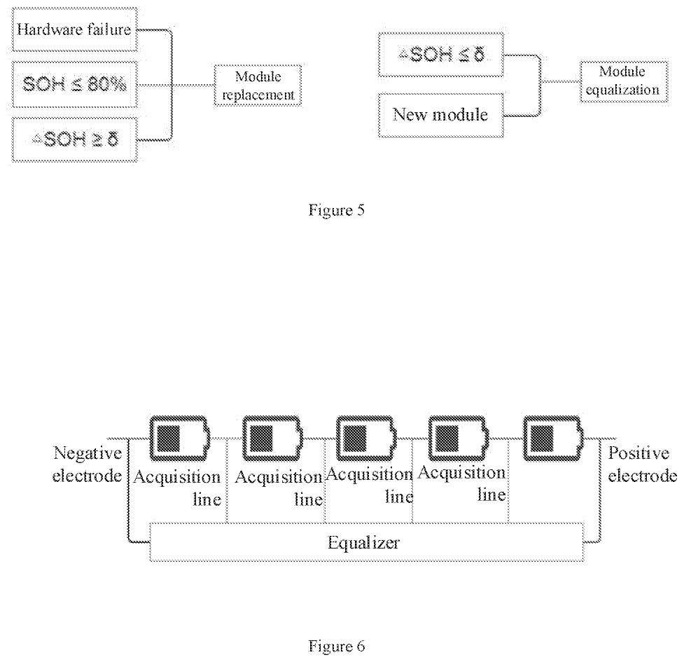

The analysis of the battery state, whether BMS or an equalizer, is based on SOC and SOH. According to the national standard, if the SOH of a battery is less than or equal to 80%, it must be replaced. In practical use, the influences of different working conditions on the SOH of a battery are different, and the SOH between different cells may be different; if the SOH difference between cells is beyond a difference threshold, the module must be replaced, and the difference thresholds are different according to different battery types, and are recorded by a database. SOH=SOCn/SOCo, where SOCn represents the current battery electric quantity when it is fully charged, and SOCo represents the initial electric quantity of the battery. In an embodiment, when the SOH of the cells in the battery is lower than a preset SOH value and the difference in the SOH of each cell in the battery is outside a difference threshold, it is determined that the battery is a replaceable battery; specifically, the preset SOH value is 80% of the initial SOC, and the difference threshold is 40%, i.e. if more than 40% of the modules in one battery fail, it is recommended to replace the whole battery. In FIG. 5, ΔSOH represents the difference in SOH of each cell, and the Õ represents the difference threshold, and the difference threshold can also be adjusted according to actual needs.

When the SOH difference between each cell in the battery is within a difference threshold, and the pressure difference between each cell in the battery exceeds a first preset pressure difference value, it is determined that the battery is a balanceable battery.

The equalization of a battery or a module is aimed at charging and discharging the module so that each cell voltage reaches a predetermined value, and the difference between the cells is within a certain range. Therefore, in battery equalization, the detection and calculation of the pressure difference of each unit in the battery are crucial. In an embodiment, the calculation method for the pressure difference of each module in the battery comprises:
marking modules needing to be detected and restored in the battery, calculating an average voltage of each module not marked in the battery, and if a difference between the voltage of each module marked in the battery and the average voltage exceeds a second preset voltage difference value, determining that the battery is a balanceable battery. The pressure difference calculation method is more accurate. In the case of ensuring safety, the equalization efficiency is improved as much as possible and the equalization time is shortened as much as possible.

In an embodiment, the calculation method for the pressure difference of each module in the battery comprises:
marking the modules needing to be detected and restored in the battery, selecting an interval unit with the highest probability of the voltage range from the voltages of each module not marked, calculating the average voltage of each module in the interval unit, and if the difference between the voltage of each module marked in the battery and the average voltage exceeds a second preset voltage difference value, determining that the battery is a balanceable battery. The pressure difference calculation method is more efficient, and the average voltage obtained by this method is more representative. Using a variety of pressure difference calculation methods, it is highly flexible and selective, and can be applied to a variety of battery equalization operations.

In an embodiment, selecting the interval unit with the highest probability of a voltage range among the voltages of the unmarked modules comprises:
selecting a maximum voltage value and a minimum voltage value from the voltages of each module which are not marked, subtracting the minimum voltage value from the maximum voltage value to obtain a voltage interval, dividing the voltage interval into a plurality of interval units according to a preset interval range, selecting an interval unit with the most distributed modules, and then calculating the average voltage of each module in the interval unit. Specifically, the maximum voltage value and the minimum voltage value are selected from the voltages of various unmarked modules, a voltage interval is acquired, the voltages are partitioned according to an interval range of 5 mV, the distribution probability of each interval unit module is counted, and the region with the highest probability is selected for average voltage counting. If the probability of regions adjacent to the highest region is also high, such regions also need to participate in the calculation of the average voltage. The width of the 5 mV region is chosen based on the fact that after equalization, the pressure difference across all the cells is generally required to be less than 5 mV.

Referring to FIG. 6, in an embodiment, when it is determined that the battery is a balanceable battery, the module in the battery is equalized by an equalizer. The positive electrode and the negative electrode of the equalization instrument are respectively connected to the positive electrode and negative electrode of the battery module, and the adjacent cells are connected to the equalization instrument via an acquisition line. Equalization methods include charging method, discharging method, high power method, cell method, etc. The charge and discharge of the positive electrode and negative electrode can allow a large current, but the current that the battery can endure has a certain range, and the magnitude of this current is closely related to the battery type and voltage range.

In an embodiment, a method for battery equalization of a battery includes:
charging and discharging a module in a battery, monitoring the voltage of each cell in the module and the temperature of the module, and shunting the equalization current between the cells, so as to ensure that the voltage difference between the cells does not exceed a first preset voltage difference value.

In an embodiment, the maximum allowable charge-discharge current is searched in the database according to the current battery model and voltage, and then the charge-discharge is performed using the maximum allowable charge-discharge current. The database records the current characteristics of charging and discharging of various batteries; when charging and discharging, the equalization instrument queries the maximum allowable charging and discharging current according to the battery model and the current battery voltage, and controls the magnitude of the charging and discharging current of the equalization instrument according to the maximum allowable charging and discharging current, so as to ensure the charging and discharging safety while maximizing the improvement of the equalization efficiency.

In an embodiment, if the minimum voltage of the module in the battery is less than the average voltage, and the maximum voltage of the module does not reach the charging cut-off voltage, the battery is equalized using a charging method. The charging method includes:
the positive electrode and negative electrode using a safe current voltage to charge the module;
monitoring cell voltage and module temperature via an acquisition line;
shunting the cell whose voltage is higher than the minimum voltage through the acquisition line to reduce the charging speed and reduce the voltage difference between cells; and
if the minimum voltage of the module is higher than the average voltage and is greater than the cut-off discharging voltage, using a discharging method to equalize the battery. The discharging method includes:
discharging the battery without supplying voltage to the positive electrode and negative electrode;
monitoring a voltage between each cell and a module temperature;
conducting shunt discharge on cells with a voltage higher than the average voltage, increasing the discharge degree, and reducing the voltage difference between cells; and
if the difference between the voltages of each module and the average voltage exceeds a second preset pressure difference value, or the pressure difference between each cell in the battery exceeds a first preset pressure difference value, using a high-power method to equalize the battery. The high-power method includes:
the positive electrode and negative electrode using a safe current voltage to charge each module;
the acquisition line monitoring each cell voltage and module temperature;
and shunting the cell acquisition line which is higher than the average voltage to adjust the battery pressure difference; wherein the first preset pressure difference value is 10 mV.
if the battery pack can be connected to the acquisition line, and the pressure difference between each cell in the battery exceeds the third preset pressure difference value or after the battery is equalized using the high-power method, the third preset pressure difference value is greater than the first preset pressure difference value, and the battery is equalized using the cell method. The cell method includes:
the positive electrode and negative electrode of the battery having no voltage output and no charging and discharging;
charging or discharging each cell through an acquisition line; and
monitoring the voltage, current and module temperature of each cell through the acquisition line, wherein the channels between each cell are independent and do not affect each other, and the third preset pressure difference is 100 mV. The safe current is the maximum charge/discharge current allowed by the battery, and is queried from a database. The safe voltage is generally slightly higher than the battery voltage. If the difference between the module voltage and the average voltage is relatively large, for example, the difference between the module voltage and the average voltage is more than 50 mV, a high-power equalization is generally used first. When the module voltage reaches approximately average voltage, a cell method is then used. If the pressure difference between cells is relatively large, for example, the pressure difference between cells is more than 100 mV, it's better to directly use the cell method. A variety of equalization methods meet the needs of different application scenarios.

In an embodiment, during the operation of the equalization instrument, the voltage of each cell and the temperature of the module are collected in real time, and whether the voltage and the temperature are within the allowable working range is monitored. If the voltage and the current of each cell and the temperature of the module exceed the allowable working range, the equalization instrument is controlled to stop operating, and an alarm signal is sent out.

In an embodiment, the charging process includes a pre-charging stage, a constant current stage, and a constant voltage charging stage in sequence. In the pre-charging stage, a small current, typically several hundred milliamps, is used for charging. After a period of pre-charging, such as one minute, a constant current stage is entered, and a large current queried from a database can be used for constant current charging. In the pre-charging stage and the constant current stage, the charging voltage is generally slightly higher than the battery voltage, for example, 0.2V higher than the battery voltage such that when the battery voltage rises, the charging voltage rises synchronously, and the same pressure difference is maintained. When the charging voltage reaches a target voltage, the charging voltage does not rise any more, and the constant voltage charging stage is entered. The constant voltage charging is performed until a certain time or the amount of charged electricity reaches a desired target, and the charging ends.

In order to ensure the accuracy of battery voltage measurement and the safety of charging and discharging, in an embodiment, when charging, if the battery voltage is higher than the open-circuit voltage, and when discharging, the battery voltage is lower than the open-circuit voltage, the intermittent method is used to charge the battery. Namely, after charging and discharging for a certain period of time, the charging is stopped for a short period of time and then continued. For example, after charging for 10 seconds, the charging is stopped for 1 second and then continued. The voltage value is relatively accurate mainly with reference to the value sampled in the stop stage. Here, the terminal voltage of the battery in an open circuit state is referred to as an open circuit voltage. The open circuit voltage of the battery is equal to the difference between the positive electrode potential and the negative electrode potential of the battery when the battery is disconnected.

In summary, the battery equalization method of the present embodiment has the following advantages.
1. Comprehensive battery analysis and repairment programs are provided to ensure the benefits of repairments, and to prevent the use of equalization methods to restore batteries without health detection which could otherwise mask battery failure conditions and fail the goal of equalization;
2. in the whole process, a computer algorithm is used to realize analysis and judgment, and the degree of intelligence is high;
3. the equalization process is safe, efficient, and accurate; and
4. a variety of equalization methods meet more application scenarios.

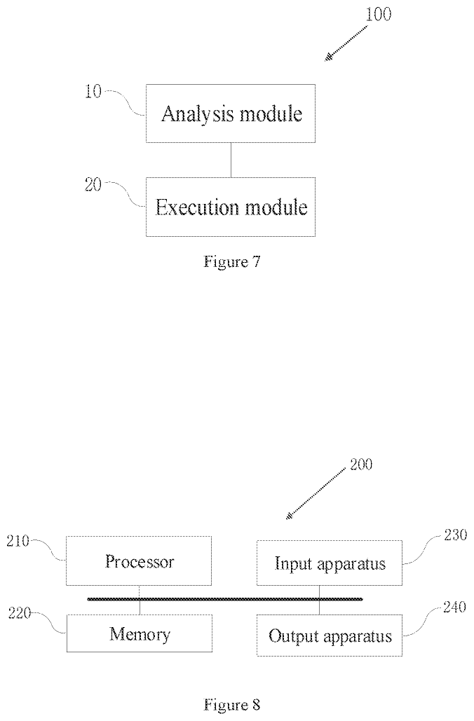

Referring to FIG. 7, an embodiment of the present invention provides a battery equalization device 100, including:
an analysis module 10 for determining whether a battery is a balanceable battery or a replaceable battery according to the acquired battery data information; and
an execution module 20 for charging and discharging a module in the balanceable battery, monitoring the voltage of each cell in the module and the temperature of the module, and shunting the equalization current between the cells, so as to ensure that the voltage difference between the cells does not exceed a first preset voltage difference value. The battery data information is acquired by using a diagnostic apparatus, comprising: one or more of battery model, software and hardware version information, total voltage, state of charge (SOC), and state of health (SOH) of a battery; one or more of the voltage, temperature, internal resistance, and fault code of a module in a battery; and one or more of the voltage, temperature, internal resistance, and fault code of a cell in the module.

In the battery equalization device 100 of the present embodiment, firstly, battery data information about a battery is acquired, then the battery can be determined on the basis of the acquired battery data information, and it is determined that the battery is a balanceable battery or a replaceable battery; and then by charging and discharging the balanceable battery, the voltage of each cell in the module and the temperature of the module are monitored, and the equalization current between each cell is shunted, so that the pressure difference between each cell does not exceed a first preset pressure difference value, thereby completing the equalization of the balanceable battery. Therefore, a battery can be effectively discriminated, thereby improving the equalization effect, shortening the equalization time, and thus improving the equalization efficiency.

It needs to be noted that the above-mentioned device embodiments and method embodiments belong to the same concept, and the specific implementation process thereof is described in detail in the method embodiments, and the technical features in the method embodiments are correspondingly applicable in the device embodiments, and the description will not be repeated here.

With reference to FIG. 8, the present embodiment also provides a schematic structural diagram of a battery equalization system 200. As shown in FIG. 8, the battery equalization system 200 comprises at least one processor 210 and a memory 220 communicatively connected to at least one processor 210. The memory 200 stores therein a program instruction executable by at least one processor 210, the program instruction being executed by at least one processor 210 to enable at least one processor 210 to execute the battery equalization method described above. One processor 210 is exemplified in FIG. 8. The battery equalization system 200 performing the battery equalization method described above may further include an input device 230 and an output device 240. Of course, other suitable device modules may be added or subtracted as desired in the actual situation.

The processor 210, memory 220, input device 230, and output device 240 can be connected through a bus or other means. A connection via a bus is taken as an example in FIG. 8. Specifically, the battery equalization system comprises an equalizer and a computer. The processor 210, the memory 220, and the input device 230 can be arranged in the computer, and the output device 240 is the equalizer. The equalizer and computer may be integrated or separate.

The memory 220, as a non-volatile computer-readable storage medium, can be used to store non-volatile software programs, and non-volatile computer-executable programs and modules, such as program instructions or modules corresponding to diagnostic methods in embodiments of the present invention. The processor 210 executes various functional applications and data processing of the server by running non-volatile software programs, instructions, and modules stored in memory 220, implementing the battery equalization method in the above method embodiments.

The memory 220 may include a program storage area and a data storage area, wherein the program storage area may store an application program required by an operating system and at least one function; and the storage data area can store data created based on the use of battery equalization device 100, etc. In addition, the memory 220 may include high-speed random access memory, as well as non-volatile memory, such as at least one disk memory device, flash memory device, or other non-volatile solid-state memory devices. In some embodiments, the memory 220 may optionally include a memory remotely provided relative to the processor 210, and examples of the aforementioned networks include but are not limited to the internet, enterprise intranet, local area network, mobile communication network, and combinations thereof.

The input device 230 may receive input numeric or character information and generate key signal inputs related to user settings and function controls of the battery equalization device 100. The output device 240 may include display equipment such as a display screen. The one or more modules are stored in the memory 220. When one or more modules are executed by one or more processors 210, the battery equalization method in any of the above method embodiments is executed.

The battery equalization system 200 of the present embodiment also has the above advantages and will not be described in detail herein.

It needs to be noted that, in the embodiment of the present invention, the method is implemented by using the battery equalization method provided in the above-mentioned embodiments. Technical details not described in detail in the method embodiments can be referred to the description of the battery equalization method provided in the embodiments of the present invention.

Finally, it should be noted that: the above embodiments are merely illustrative of the technical solutions of the present invention, rather than limiting it; combinations of technical features in the above embodiments or in different embodiments are also possible under the idea of the present invention, and the steps can be implemented in any order; there are many other variations of the different aspects of the present invention as described above, which are not provided in detail for the sake of brevity; although the present invention has been described in detail with reference to the foregoing embodiments, those of ordinary skills in the art will appreciate that the technical solutions disclosed in the above-mentioned embodiments can still be modified, or some of the technical features thereof can be replaced by equivalents; such modifications or replacements do not depart the essence of the corresponding technical solution from the scope of the technical solutions of embodiments of the present invention.

1. A battery equalization method, comprising:
according to acquired data information of a battery, determining that the battery is a balanceable battery or a replaceable battery;
charging and discharging a module in the balanceable battery;
monitoring voltages of each cell in the module and a temperature of the module; and
shunting an equalization current between the cells, so as to ensure that a voltage difference between the cells does not exceed a first preset voltage difference value.

2. The battery equalization method according to claim 1, wherein the according to acquired data information of a battery, determining that the battery is a balanceable battery or a replaceable battery comprises: querying a database, comparing the acquired data information of a battery with the database, analyzing whether the battery has a fault, and then determining whether the battery is a balanceable battery or a replaceable battery according to a result of analyzing whether the battery has a fault.

3. The battery equalization method according to claim 1, wherein the according to acquired data information of a battery, determining that the battery is a balanceable battery or a replaceable battery comprises: analyzing whether the battery has a fault via BMS, and then determining whether the battery is a balanceable battery or a replaceable battery according to a result of analyzing whether the battery has a fault; or, if it is not possible to analyze whether the battery has a fault via BMS, performing repairment detection on the battery via an equalizer, analyzing whether the battery has a fault, and then determining whether the battery is a balanceable battery or a replaceable battery according to the result of analyzing whether the battery has a fault.

4. The battery equalization method according to claim 3, wherein when it is determined that the battery is a replaceable battery, after a replacement of the replaceable battery, a replaced battery is equalized as a balanceable battery.

5. The battery equalization method according to claim 3, wherein the performing repairment detection on the battery via an equalizer, analyzing whether the battery has a fault, and then determining whether the battery is a balanceable battery or a replaceable battery according to the result of analyzing whether the battery has a fault comprise:
analyzing whether the battery has a fault by using an internal resistance method via the equalization instrument, and then determining whether the battery is a balanceable battery or a replaceable battery according to the result of the analyzing whether the battery has a fault, and
if the internal resistance method cannot be determined, determining the battery to be a replaceable battery or a balanceable battery by analyzing the battery using a deep charge-discharging method via the equalization instrument.

6. The battery equalization method according to claim 5, wherein analyzing the battery using a deep charge-discharging method via the equalization instrument comprises:
firstly charging the battery with a current, after cells in the battery are fully charged, deeply discharging each cell, and when SOH of the cells in the battery is lower than a preset SOH value and a difference of the SOH of each cell in the battery is outside a difference threshold, determining that the battery is a replaceable battery;
when a SOH difference between each cell in the battery is within a difference threshold, and the pressure difference between each cell in the battery exceeds a first preset pressure difference value, determining that the battery is a balanceable battery;
or marking modules needing to be detected and restored in the battery, calculating an average voltage of each module not marked in the battery, and if a difference between a voltage of each module marked in the battery and the average voltage exceeds a second preset voltage difference value, determining that the battery is a balanceable battery.

7. The battery equalization method according to claim 6, wherein marking the modules needing to be detected and restored in the battery, selecting an interval unit with a highest probability of a voltage range from the voltages of each module not marked, calculating the average voltage of each module in the interval unit, and if the difference between the voltage of each module marked in the battery and the average voltage exceeds a second preset voltage difference value, determining that the battery is a balanceable battery.

8. The battery equalization method according to claim 7, wherein selecting an interval unit with a highest probability of a voltage range from the voltages of each module not marked comprises:
selecting a maximum voltage value and a minimum voltage value from the voltages of each module not marked, obtaining a voltage interval by a difference between the maximum voltage value and the minimum voltage value, dividing the voltage interval into a plurality of interval units according to a preset interval range, selecting an interval unit with most distributed modules, and then calculating the average voltage of each module in the interval unit.

9. The battery equalization method according to claim 1, wherein a module in the balanceable cell is charged and discharged by the equalization instrument, the voltage of each cell in the module and the temperature of the module are monitored, and an equalization current between the cells is shunted to ensure that the pressure difference between the cells does not exceed a first preset pressure difference value.

10. The battery equalization method according to claim 1, wherein the battery data information is acquired by using a diagnostic apparatus, comprising: one or more of battery model, software and hardware version information, total voltage, SOC, and SOH of the battery;
one or more of voltage, temperature, internal resistance, and fault code of a module in the battery; and
one or more of the voltage, temperature, internal resistance, and fault code of a cell in the module.

11. The battery equalization method according to claim 1, wherein a maximum allowable charge-discharge current is queried in a database according to a current battery model and voltage, and then charge-discharge is performed by using the maximum allowable charge-discharge current.

12. The battery equalization method according to claim 1, wherein, if a minimum voltage of a module in the battery is less than an average voltage and a maximum voltage of the module does not reach a charging cutoff voltage, a charging method is used to equalize the battery, wherein the charging method comprises:
using a safe current voltage to charge the module;
monitoring a cell voltage and a module temperature; and
shunting a cell having a voltage higher than the minimum voltage;
if the minimum voltage of the module is higher than the average voltage and is greater than the cut-off discharging voltage, a discharging method is used to equalize the battery, wherein the discharging method comprises:
discharging the battery;
monitoring the voltage between each cell and the module temperature; and
performing a shunt discharge on a cell having a voltage higher than the average voltage;
if the difference between the voltages of each module and the average voltage exceeds a second preset pressure difference value, or the pressure difference between each cell in the battery exceeds a first preset pressure difference value, a high-power method is used to equalize the battery, wherein the high-power method comprises:
using a safe current voltage to charge each module;
monitoring each cell voltage and module temperature; and
shunting cells above the average voltage; and
if a battery pack can be connected to an acquisition line, and the pressure difference between each cell in the battery exceeds a third preset pressure difference value or after the battery is equalized using the high-power method, the third preset pressure difference value is greater than the first preset pressure difference value, the battery is equalized using a cell method, wherein the cell method comprises:
a positive electrode and negative electrode of the battery having no voltage output and no charging and discharging;
charging or discharging each cell through the acquisition line; and
monitoring the voltage, current and module temperature of each cell through the acquisition line.

13. The battery equalization method according to claim 12, wherein if the voltage, the current and the module temperature of each cell exceed an allowable working range, the equalizer is controlled to stop working and an alarm signal is sent out.

14. The battery equalization method according to claim 12, wherein a charging process comprises pre-charging stage, constant current stage, and constant voltage charging stage in sequence.

15. The battery equalization method according to claim 12, wherein the battery is charged intermittently if the voltage of the battery is higher than an open-circuit voltage during charging and if the voltage of the battery is lower than the open-circuit voltage during discharging.

16. A battery equalization system, comprising at least one processor and a memory connected in communication with the at least one processor;
wherein the memory stores an instruction program executable by the at least one processor, the instruction program being executed by the at least one processor to enable the at least one processor to execute a battery equalization method comprising steps of:
according to acquired data information of a battery, determining that the battery is a balanceable battery or a replaceable battery:
charging and discharging a module in the balanceable battery;
monitoring voltages of each cell in the module and a temperature of the module; and
shunting an equalization current between the cells, so as to ensure that a voltage difference between the cells does not exceed a first preset voltage difference value.

17. The battery equalization system according to claim 16, wherein the at least one processor executes the step of according to acquired data information of a battery, determining that the battery is a balanceable battery or a replaceable battery, the at least one processor further executes a step of; querying a database, comparing the acquired data information of a battery with the database, analyzing whether the battery has a fault, and then determining whether the battery is a balanceable battery or a replaceable battery according to a result of analyzing whether the battery has a fault.

18. The battery equalization system according to claim 16, wherein the at least one processor executes the step of according to acquired data information of a battery, determining that the battery is a balanceable battery or a replaceable battery, the at least one processor further executes a step of: analyzing whether the battery has a fault via BMS, and then determining whether the battery is a balanceable battery or a replaceable battery according to a result of analyzing whether the battery has a fault; or, if it is not possible to analyze whether the battery has a fault via BMS, performing repairment detection on the battery via an equalizer, analyzing whether the battery has a fault, and then determining whether the battery is a balanceable battery or a replaceable battery according to the result of analyzing whether the battery has a fault.

19. The battery equalization system according to claim 18, wherein when it is determined that the battery is a replaceable battery, after a replacement of the replaceable battery, a replaced battery is equalized as a balanceable battery.

20. The battery equalization system according to claim 18, wherein the at least one processor executes the step of performing repairment detection on the battery via an equalizer, analyzing whether the battery has a fault, and then determining whether the battery is a balanceable battery or a replaceable battery according to the result of analyzing whether the battery has a fault, the at least one processor further executes a step of:
analyzing whether the battery has a fault by using an internal resistance method via the equalization instrument, and then determining whether the battery is a balanceable battery or a replaceable battery according to the result of the analyzing whether the battery has a fault; and
if the internal resistance method cannot be determined, determining the battery to be a replaceable battery or a balanceable battery by analyzing the battery using a deep charge-diseharging method via the equalization instrument.
